(19) United States
(12) Patent Application Publication
(10) Pub. No.: US 2013/0164088 A1
(43) Pub. Date: Jun. 27, 2013

(54) DRILL FOR COMPOSITE MATERIALS

(71) Applicant: Peter Diamantis, Spartanburg, SC (US)

(72) Inventor: Peter Diamantis, Spartanburg, SC (US)

(21) Appl. No.: 13/333,438

(22) Filed: Dec. 21, 2011

(51) Int. Cl. B23B 51/02; B23B 51/00

(52) U.S. Cl. 408/145; 408/199

(57) ABSTRACT

An improved drill is provided with a negative rake angle, a positive flute rake angle, and a positive relief angle. The drill may include a chip breaker disposed within a flute along the shank of the drill.

### TECHNICAL FIELD

The present invention relates generally to an improved drill especially adapted for composite materials and, more particularly, to a drill with a chip breaker and with a leading cutting tooth point disposed interior to the outer radius of the drill.

### BACKGROUND

Engineering the configuration of tooling to drill into materials requires balancing multiple variables. These variables include feed rate, cutting precision, tool longevity, chip evacuation, rigidity, tensile strength, span time, and cut smoothness. The components and geometries of past drills have involved various combinations seeking to maximize one or more of such variables, but often at the sacrifice of other such variables.

The engineering of drills for composite materials is especially challenging. Composites involve non-uniform interior textures. Furthermore, composites such as carbon fiber reinforced plastics are very abrasive. Particular challenges have focused on creating smooth holes, without frayed carbon fibers left in the opening; uniformly- and precisely-dimensioned holes using the same drill; drilling depth, as the “chips” from drilling composites differ significantly from those of drilling for example metals; and tool longevity.

What has been needed is a drill that cuts precisely-dimensioned holes, time after time. Such a tool should have an extended tool life. It should provide for a smooth, regular perimeter to the drilled hole, without frayed fibers lingering from the process. And it should provide the capability of drilling deeply through several layers rather than being limited to thin-panel applications.

### SUMMARY OF THE INVENTION

A new, improved drill is disclosed. As revealed in the following description and the appended figures, this invention discovers an efficient and useful drill configuration that achieves several elusive drilling objectives for composite material.

In accordance with certain aspects of certain embodiments of the present subject matter, a drill is provided that includes a bore radius. The drill may include a cutting tooth that defines a negative rake angle, a positive flute rake angle, and/or a positive relief angle. The drill may include a trailing edge that may reside at the bore radius. The drill may also include a cleaning notch that may reside at the bore radius between the cutting tooth and the trailing edge.

In certain embodiments, the drill may include a flute. The flute may be a straight flute or it may include a helical flute, as circumstances may reveal to be advantageous.

The drill may also include a chip breaker. The chip breaker may be disposed within the flute. In certain embodiments, the chip breaker may reside axially within the flute. The chip breaker may include a leading chip breaker point.

In certain aspect of some embodiments, the negative rake angle may be between three and twelve degrees. In still other embodiments, the positive flute rake angle may be between five and fifteen degrees.

In other aspects of certain embodiments of the present invention, the drill may have an axis of rotation and a bore radius and may include a cutting end with a cutting tooth, a trailing edge, and a cleaning notch residing between the cutting tooth and the trailing edge. The drill cutting tooth may have a tooth angle greater than ninety degrees. A cleaning notch may be included and may reside at the bore radius. Further, the cutting tooth may comprise a leading tooth point that may reside between the axis of rotation and the bore radius, the leading tooth point residing below the cleaning notch and the trailing edge.

In still further embodiments of the present invention, the trailing edge may reside along the bore radius.

In still further embodiments, the drill may comprise a flute. In some aspects of the present invention, a chip breaker may be included, disposed within the flute. In certain embodiments, the chip breaker may include a leading point.

In still other embodiments of the present invention, the drill may be understood to include a shank that has an axis of rotation. The drill may further include a cutting end disposed at the end of the shank, the cutting end defining a bore radius. A flute may be defined in the shank in certain embodiments, with the flute terminating at the cutting end in some aspects.

In still further aspects of the present invention, the cutting end may comprise a cutting tooth extending inwardly from the bore radius and defining an acute angle to the bore radius in a plane perpendicular to the axis of rotation. In some embodiments, the cutting tooth may have a tooth angle of at least ninety degrees. In certain aspects of the present invention, the cutting tooth may have a leading tooth point disposed between the axis of rotation and the bore radius.

In certain embodiments, the leading tooth point may constitute the terminal end of the drill.

In still further embodiments, a chip breaker may be included that is disposed within the flute.

Certain aspects of the present invention may also include a trailing edge disposed at the cutting end of the drill and concentric to the axis of rotation.

In yet still further additional aspects of the present invention, the drill may include a cleaning notch disposed at the cutting end at the bore radius, between the cutting tooth and the trailing edge.

In certain aspects of certain embodiments of the present invention, the acute angle defined by the cutting tooth extending inwardly from the bore radius in a plane perpendicular to the axis of rotation may be between five and fifteen degrees.

In certain aspects of the present invention, the drill may be carbide. In certain particular aspects, the drill may have physical vapor deposition coating and/or chemical vapor deposition coating. In yet other aspects, the drill may include a cutting tooth that is polycrystalline diamond.

### BRIEF DESCRIPTION OF THE DRAWINGS

The details of the present invention, both as to its structure and as to its operation can be understood with reference to the accompanying figures. It should be noted that these figures are not necessarily to scale in all instances.

FIG. 1 is a perspective view of an improved drill in accordance with certain aspects of the present invention;

FIG. 2 is a side elevation view of an improved drill in accordance with certain aspects of the present invention;

FIG. 3 is a side elevation view, from a perspective different than in FIG. 2, of an improved drill in accordance with certain aspects of the present invention;

FIG. 4 is an end view of an improved drill in accordance with certain aspects of the present invention, from the perspective of the cutting end of the drill;

FIG. 5 is a partial side view of the cutting end of the improved drill in accordance with certain aspects of the present invention.

### DETAILED DESCRIPTION

Reference will now be made in detail to the presently preferred embodiments of the invention, one or more examples of which are illustrated in the figures. Each example is provided by way of explanation of the invention and not meant to be a limitation of the invention. For example, features illustrated or described as part of one embodiment may be used with a different embodiment to yield yet still a further embodiment. It is intended that the present application includes such modifications and variations as come within the scope and spirit of the invention. Selected combinations or aspects of the disclosed technology correspond to a plurality of different embodiments of the present invention. Certain features may be interchanged with similar devices or different features not expressly mentioned, that perform the same or similar functions.

The present invention of an improved drill 10 may include an axis of rotation 11, a bore radius 12, a cutting tooth 20, a cleaning notch 30, a trailing edge 40, a shank 50, a flute 60, and a chip breaker 70.

Drill 10 may be fabricated of carbide. For certain advantageous reasons in particular situations, drill 10 may have physical vapor deposition coating and/or chemical vapor deposition diamond coating.

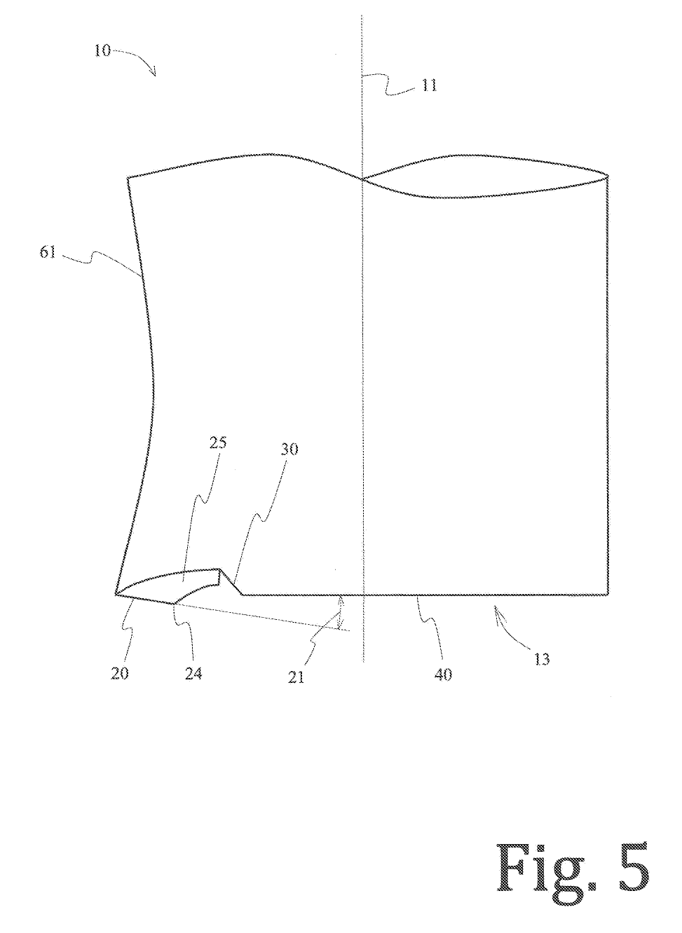

In use, rotating about axis of rotation 11, drill 10 has a bore radius 12 about cutting end 13. Cutting end 13 includes several components. First, cutting end 13 includes cutting tooth 20. Cutting tooth 20 may have several features. Cutting tooth 20 may form a rake angle 21. Rake angle 21 may be understood to be that angle that is formed by cutting tooth 20 along its leading edge, as cutting tooth 20 extends inwardly from bore radius 12, relative to an imaginary plane normal to axis of rotation 11. In certain situations, a negative rake angle 21 has been found to be advantageous. In particular embodiments, a negative rake angle 21 of between three and twelve degrees has been found effective in drilling composite materials. For example, a negative rake angle 21 of six degrees may be particularly advantageous in drilling certain carbon fiber reinforced plastics. Understanding the geometry of a negative rake angle 21, cutting tooth 20 can be further understood to provide a leading tooth'point 24 that may constitute the terminal end of drill 10. As such, when using drill 10, leading tooth point 24 would contact the material to be drilled first as drill 20 is lowered toward the working material. Stated differently, leading tooth point 24 would reside below cleaning notch 30 and trailing edge 40 (see, for example, FIG. 5), and likewise would reside between the axis of rotation 11 of drill 20 and bore radius 12.

Leading tooth point 24 may also be understood to include a tooth angle 22. The measure of tooth angle 22 bears upon several variables, including the longevity of drill 10. As can be appreciated, a tooth angle 22 of less than ninety degrees would include relatively less material supporting tooth angle 22 and might therefore wear more quickly. Conversely, a tooth angle 22 of greater than ninety degrees would include relatively more material supporting tooth angle 22 and therefore promote longevity of drill 10. In certain embodiments of the present invention, it has been found that a tooth angle 22 greater than ninety degrees may be preferred.

Cutting tooth 20 may also be understood to include a flute rake angle 63. As the edge of cutting tooth 20 is observed to extend inwardly from bore radius 12, flute rake angle 63 may be understood to be defined as that angle between cutting tooth 20 and an imaginary line extending from axis of rotation 11 to the end of cutting tooth 20 that resides at bore radius 12. In certain circumstances, a positive flute rake angle 63 may be preferred, in part as contributing to the geometry of tooth angle 22 exceeding ninety degrees. In certain embodiments for use in particular applications, a flute rake angle 63 of about ten degrees may be desired. In other embodiments, a flute rake angle 63 of between five and fifteen degrees may be preferred.

Cutting tooth 20 may also be understood to have a tooth ramp 25 extending rearwardly from cutting tooth 20. Within such geometry, a relief angle 23 may be defined, constituting the angle at which tooth ramp 20 resides relative to an imaginary plane normal to axis of rotation 11. For applications involving drilling composite materials, a positive relief angle 23 of between five and fifteen degrees may be desirable. In particular applications, a positive relief angle of ten degrees may be preferred.

Drill 10 may also a trailing edge 40. Trailing edge 40 may be formed along the bore radius 12, residing behind cutting tooth 20. Trailing edge 40 may be formed to a sharpened terminal edge at cutting end 13 and may be concentric to axis of rotation 11. So configured with a sharpened terminal edge, trailing edge 40 may contribute to drilling of cleaner edges to holes drilled with drill 10.

Drill 10 may also include a cleaning notch 30. Cleaning notch 30 may be formed at cutting end 13 along bore radius 12 and may reside between cutting tooth 20 and trailing edge 40. In certain situations with certain composite materials, it may be preferred to have a cleaning notch 30 so as to trim and cut stray fibers from a composite material that might otherwise be left protruding into a hole drilled with drill 10.

Drill 10 may also include a flute 60. A flute 60 may be useful in certain applications to provide for the evacuation of materials cut during the drilling process in use of drill 10. Flute 60 in certain applications may be straight, parallel to axis of rotation 11. In other applications, it may be found that a helical flute 60 is preferred in promoting evacuation of drilled waste material. Flute 60 may be terminated at cutting end 13 and proceed upwardly along drill 10 to a distance exceeding the depth of hole to be drilled.

It has also been discovered that inclusion of a chip breaker 70 within flute 60 can be advantageous in certain drilling circumstances with use of drill 10. Chip breaker 70 may be disposed above the cutting end 13 of drill 10, so that it contacts waste material generated as drill 10 is progressed downwardly through the worked material. In certain applications, it has been found to configure chip breaker 70 axially, parallel to axis of rotation 11 within flute 60. For certain applications, chip breaker 70 may be configured to include chip breaker point 71, chip breaker point 71 being a sharpened lower end to chip breaker 70 of particular utility in breaking waste from the worked material into smaller pieces that are thereby more easily evacuated during use of drill 10.

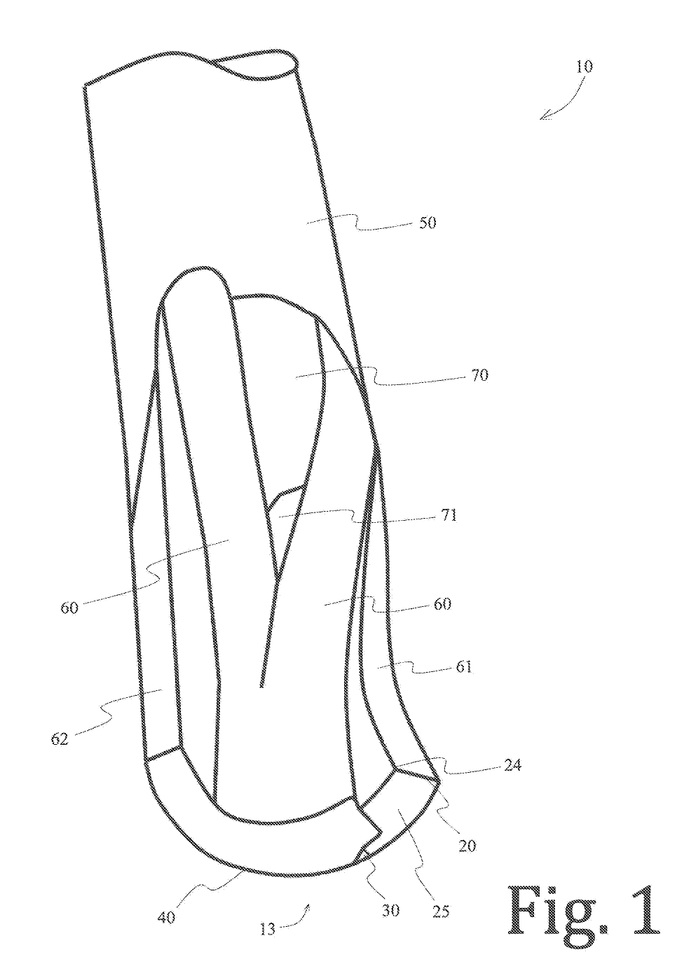

FIG. 1 illustrates one embodiment of the present invention. As depicted therein, cutting tooth 20, cleaning notch 30, trailing edge 40, and chip breaker 70 within flute 60 had been configured to provide an improved drill. Tooth ramp 25 is depicted as following cutting tooth 20, followed still by cleaning notch 30 and trailing edge 40. Flute leading edge 61 and flute trailing edge 62 terminate at cutting end 13, to define the front and rear of cutting end 13. Furthermore, chip breaker 70 has been configured to include chip breaker point 71.

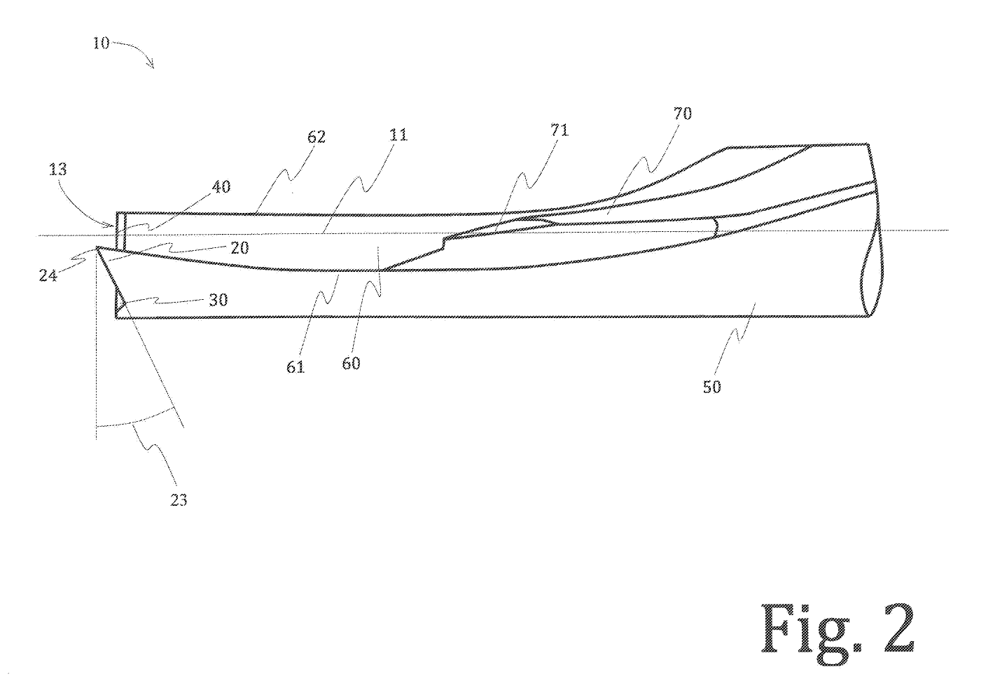

FIG. 2 illustrates certain other aspects of particular embodiments of drill 10. As illustrated therein, positive relief angle 23 is depicted relative to leading tooth point 24 of cutting tooth 20. Axis of rotation 11 is likewise illustrated.

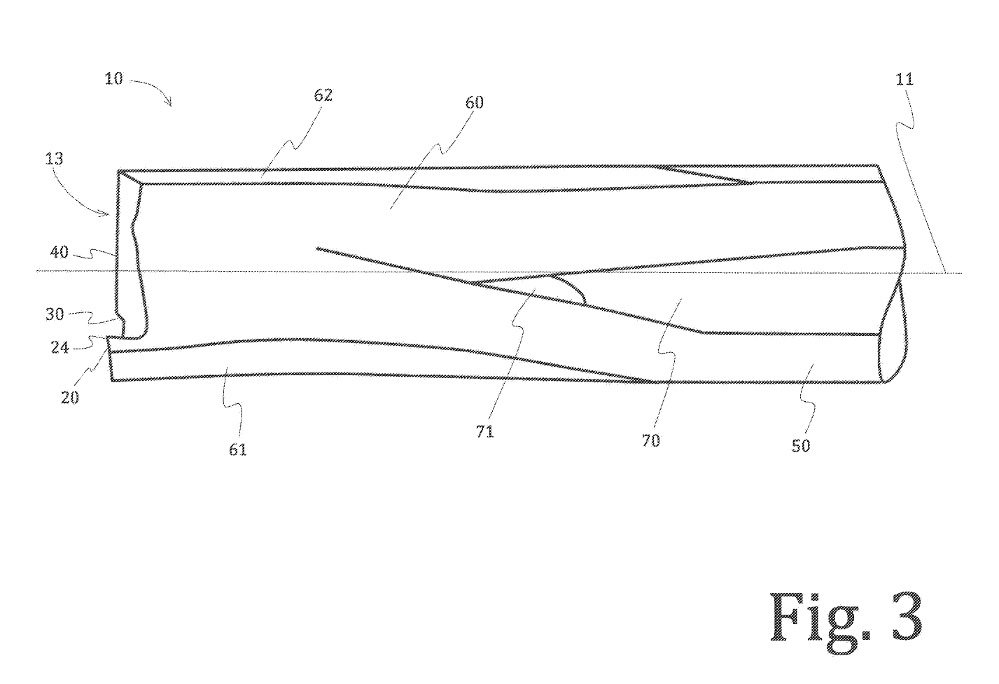

FIG. 3 depicts certain other aspects of particular embodiments of drill 10. As shown therein, axis of rotation 11 extends along drill 10. Cutting end 13 is depicted at the left of drill 10, but it will be understood that, in use, drill 10 would be oriented vertically such that cutting end 13 is at the bottom of drill 10 (such as is depicted in FIG. 5). So defined, leading tooth point 24 is illustrated as constituting the terminal end of drill 10; upward from leading tooth point 24 is, first, trailing edge 40, then cleaning notch 30. Still further upward is disposed, first, chip breaker point 71 and chip breaker 70.

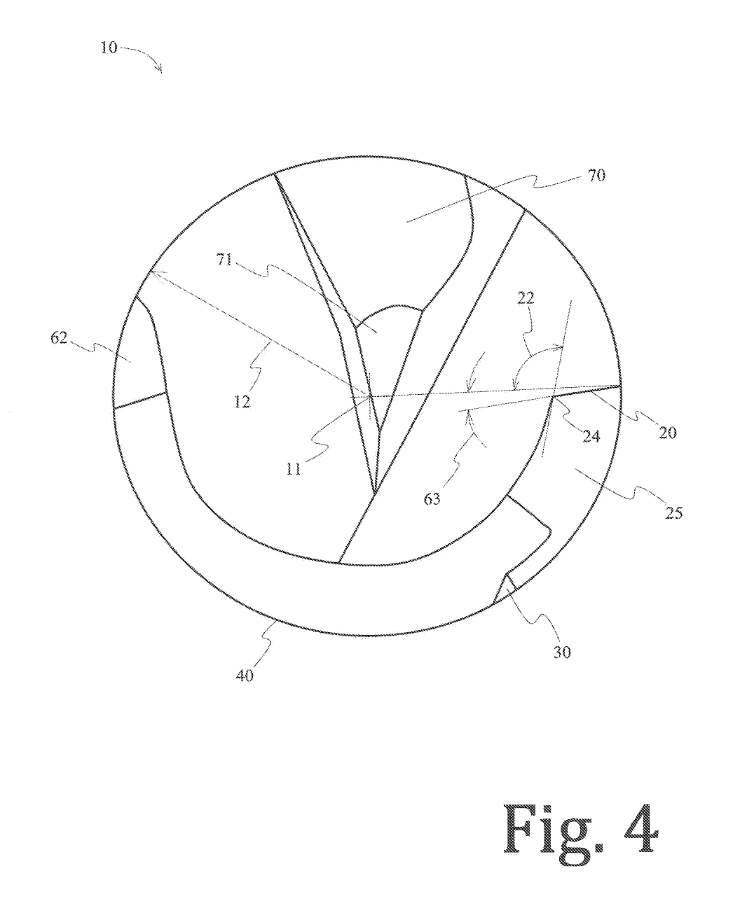

FIG. 4 is an end view of drill 10 taken from the perspective of cutting end 13. As shown, drill 10 includes a bore radius 12 extending from axis of rotation 11 to the outer periphery of drill 10. Along bore radius 12 are disposed trialing edge 40 and cutting notch 30. FIG. 4 depicts tooth angle 22; in FIG. 4 tooth angle 22 is shown as exceeding ninety degrees between cutting tooth 20 and an imaginary line tangential to the interior surface of cutting edge 20 at leading tooth point 24. Likewise, FIG. 4 depicts positive flute rake angle 63, as defined between an imaginary line extending from axis of rotation 11 through the edge of cutting tooth 20 residing at bore radius 12. Tooth ramp 25 is also illustrated as extending behind cutting tooth 20 toward cleaning notch 30. In some applications, tooth ramp 25 may be planar; in other applications, tooth ramp 25 may be curvilinear and non-planar, as may be desirable for certain applications.

FIG. 5 illustrates certain other aspects of other embodiments of drill 10. Particularly, FIG. 5 shows negative rake angle 21 as defined between the line formed by cutting tooth 20 and an imaginary plane normal to axis rotation 11 at, for example, trailing edge 40.

Drill 10, so configured, provides an efficient and effective improved drill. Drill 10 cuts precisely-dimensioned holes, time after time. It exhibits extended tool life and provides a smooth, regular perimeter to drilled holes without frayed fibers resulting from the process. It also provides the capability of drilling deeply through several layers of material, rather than being limited to thin-panel applications.

As disclosed herein, the present invention provides an improved drill that includes a negative rake angle and a chip breaker. While preferred embodiments of the invention have been shown and described, modifications and variations may be made thereto without departing from the spirit and scope of the present invention. Thus, it should be understood that various embodiments may be interchanged, either in whole or in part. Furthermore, those with skill in this technology will appreciate that the foregoing description is by way of example only and is not intended to be a limitation of the invention as further described in the appended claims.

1. A drill having a bore radius, comprising:
A cutting tooth, the cutting tooth defining a negative rake angle, a positive flute rake angle, and a positive relief angle;
A trailing edge, the trailing edge residing at the bore radius; and
A cleaning notch, the cleaning notch residing at the bore radius between the cutting tooth and the trailing edge.

2. The drill of claim 1, further comprising a flute.

3. The drill of claim 2, wherein the flute is straight.

4. The drill of claim 2, wherein the flute is helical.

5. The drill of claim 2, further comprising a chip breaker, the chip breaker disposed within the flute.

6. The drill of claim 5, wherein the chip breaker resides axially within the flute.

7. The drill of claim 2, wherein the rake angle is between three and twelve degrees.

8. The drill of claim 2, wherein the flute rake angel is between five and fifteen degrees.

9. A drill having an axis of rotation and a bore radius, comprising:
A cutting end having a cutting tooth, a trailing edge, and a cleaning notch residing between the cutting tooth and the trailing edge;
The cutting tooth having a tooth angle greater than ninety degrees;
The cleaning notch residing at the bore radius;
The cutting tooth comprising a leading tooth point, the leading tooth point residing between the axis of rotation and the bore radius, the leading tooth point residing below the cleaning notch and the trailing edge.

10. The drill of claim 7, wherein the trailing edge resides along the bore radius.

11. The drill of claim 7, further comprising a flute.

12. The drill of claim 8, further comprising a chip breaker, the chip breaker disposed within the flute.

13. The drill of claim 10, wherein the chip breaker includes a leading point.

14. A drill, comprising:
A shank, the shank having an axis of rotation;
A cutting end disposed at an end of the shank, the cutting end defining a bore radius;
A flute defined into the shank, the flute terminating at the cutting end;
The cutting end comprising a cutting tooth, the cutting tooth extending inwardly from the bore radius defining an acute angle to the bore radius in a plane perpendicular to the axis of rotation, the cutting tooth having a tooth angle of at least ninety degrees, the cutting tooth having a leading tooth point, the leading tooth point disposed between the axis of rotation and the bore radius and constituting the terminal end of the drill; and
A chip breaker, the chip breaker disposed within the flute.

15. The drill of claim 14, further comprising a trailing edge, the trailing edge disposed at the cutting end and concentric to the axis of rotation.

16. The drill of claim 15, further comprising a cleaning notch, the cleaning notch disposed at the cutting end at the bore radius between the cutting tooth and the trailing edge.

17. The drill of claim 16, wherein the acute angle is between five and fifteen degrees.

18. The drill of claim 17, wherein the drill is carbide.

19. The drill of claim 18, wherein the drill has vapor deposition coating.

20. The drill of claim 18, wherein the cutting tooth is polycrystalline diamond.
